(19) United States
(12) Patent Application Publication
(10) Pub. No.: US 2019/0130429 A1
(43) Pub. Date: May 2, 2019

(54) CUSTOMIZED ACTIVITY-BASED REWARD GENERATION

(71) Applicant: Walmart Apollo, LLC, Bentonville, AR (US)

(72) Inventors: Shilka Roy, Noida (IN); Shreyan Ghosh, Kolkata (IN); Manohar Maddineni, Bangalore (IN)

(21) Appl. No.: 15/838,357

(22) Filed: Dec. 12, 2017

(30) Foreign Application Priority Data
Oct. 31, 2017 (IN) 201741038665

(51) Int. Cl. G06Q 30/02; G01C 21/20

(52) U.S. Cl. CPC G06Q 30/0226; G01C 21/206; G06Q 30/0222; G06Q 30/0235

(57) ABSTRACT

Examples provide an activity reward generator for generating customized activity-based rewards. A per-user activity threshold is generated for a user based on user data and/or transaction history data. A customized minimum transaction threshold is generated based on retail environment data and/or transaction history data associated with a retail environment. An amount of activity performed by a user within the retail environment is calculated based on activity data and an activity type for the user. If the calculated amount of activity exceeds the per-user activity threshold and a transaction total for a selected transaction completed by the user exceeds the customized minimum transaction threshold, reward point(s) corresponding to the amount of activity are given to the user. If the total number of reward points of the user exceeds a minimum rewards points threshold, providing a customized reward to the user.

### BACKGROUND

A fitness tracker is a device for monitoring physical activity of a user. For example, a pedometer is a type of fitness tracker which counts the number of steps taken by a person wearing or carrying the pedometer. User's frequently utilize a fitness tracker to determine how many steps the user has taken or how many calories the user has burned during exercise or throughout a day. Fitness trackers may also be utilized to determine whether a user has reached an activity goal, such as a minimum number of steps taken each day. However, user's may not always have their fitness tracker with them while performing activities which would further their fitness goals. In such cases, user's may fail to recognize or account for all their daily activities resulting in a perceived failure to meet goals and/or frustration by users.

Moreover, some users may find it difficult to meet their daily or weekly goals due to lack of time, bad weather precluding use of outdoor walking areas, running errands, or other circumstances which may make it more difficult for a user to accomplish their goals. Other users may fail to accomplish fitness goals due to a lack of motivation or a perceived lack of incentives for meeting daily goals. This may result in users prematurely abandoning their fitness efforts or becoming discouraged with their attempts to meet long-term goals.

### SUMMARY

Examples of the disclosure provide a system for activity-based reward generation. The system includes a memory and at least one processor communicatively coupled to the memory. A threshold generator generates a per-user minimum activity threshold and activity type based on context data associated with a retail environment, user data and transaction data associated with a plurality of transactions completed by an identified user over a predetermined time-period. An activity verification component analyzes verification data received from a user device and/or a set of sensor devices associated with the retail environment. The activity verification component verifies that an activity value associated with the identified user exceeds the per-user minimum activity threshold for the activity type. The activity value indicates an amount of activity prior to completion of a selected transaction by the identified user. A transaction verification component analyzes transaction data to verify a transaction total associated with the selected transaction exceeds a minimum transaction threshold. An incentives generator assigns a number of reward points to the identified user if the transaction total exceeds the minimum transaction threshold and the activity value exceeds the per-user minimum activity threshold prior to completion of the selected transaction.

Other examples provide a computer-implemented method for activity-based reward generation. A threshold generator generates a customized minimum activity threshold for an identified user entering a retail environment based on a set of activity variables and data associated with the retail environment. An activity tracker calculates an amount of activity performed by the identified user within the retail environment within a time-period between entering the retail environment and completing a selected transaction associated with obtaining a set of items. A transaction verification component analyzes transaction data associated with the selected transaction to verify a transaction total associated with the selected transaction exceeds a minimum transaction threshold. An incentives generator assigns a set of rewards points corresponding to the amount of activity performed to the user if the amount of activity performed exceeds the customized minimum activity threshold and the transactions total exceeds the minimum transaction threshold.

Still other examples provide one or more computer storage media, having computer-executable instructions for activity-based reward generation. The computer-executable instructions, when executed by a computer, cause the computer to perform operations for generating a customized minimum transaction threshold for an identified user entering a retail environment based on retail environment data associated with the retail environment and transaction data. The transaction data includes data associated with a plurality of transactions of the retail environment over a predetermined time-period. A transaction total is calculated for a selected transaction completed by the identified user. If the calculated transaction total exceeds the customized minimum transaction threshold, an amount of activity is calculated. The amount of activity quantifies activity performed by the identified user within the retail environment during a time-period between entering the retail environment and completing the selected transaction. On condition the amount of activity performed by the identified user exceeds a minimum activity threshold for the identified user, a number of rewards points corresponding to the amount of activity performed by the user is calculated. On condition a threshold maximum number of rewards points exceeds the calculated number of rewards points, the calculated number of reward points is assigned to the identified user.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

### BRIEF DESCRIPTION OF THE DRAWINGS

FIG. 1 is an exemplary block diagram illustrating a computing device generating customized activity-based rewards.

FIG. 2 is an exemplary block diagram illustrating an activity rewards generator.

FIG. 3 is an exemplary block diagram illustrating a retail environment.

FIG. 4 is an exemplary block diagram illustrating a plurality of data sources.

FIG. 5 is an exemplary block diagram illustrating a time-out component.

FIG. 6 is an exemplary block diagram illustrating a route generation component.

FIG. 7 is an exemplary block diagram illustrating a recommended route.

FIG. 8 is an exemplary block diagram illustrating another recommended route.

FIG. 9 is an exemplary block diagram illustrating a customized reward generator.

FIG. 10 is an exemplary flow chart illustrating operation of the computing device to verify an activity value based on a customized minimum activity threshold for a user.

FIG. 11 is an exemplary flow chart illustrating operation of the computing device to assign reward points based on a customized minimum activity threshold and a customized minimum transaction threshold.

FIG. 12 is an exemplary flow chart illustrating operation of the computing device to assign a customized reward to a user.

FIG. 13 is an exemplary flow chart illustrating operation of the computing device to track user activity within a retail environment.

FIG. 14 is an exemplary block diagram of an activity tracker application log-in screen.

FIG. 15 is an exemplary block diagram of an activity tracker application cart contents screen.

FIG. 16 is an exemplary block diagram of an activity tracker application activity tracker statistics screen.

FIG. 17 is an exemplary block diagram of an activity tracker application award notification screen.

Corresponding reference characters indicate corresponding parts throughout the drawings.

### DETAILED DESCRIPTION

Referring to the figures, examples of the disclosure enable customized activity-rewards generation. In some examples, an activity rewards generator utilizes user data, retail environment data, and/or transaction history data to generate a per-user minimum activity threshold customized to a particular user's goals, habits and/or abilities. Reward points are awarded to a user if the user performs activity within a retail environment that exceeds the customized minimum activity threshold generated for the user. This enables a different threshold of activity to be applied to each unique user based on the user's physical abilities, previous shopping trips, habits, customs, etc. In this manner, the rewards generator provides an activity goal that is appropriate for each user based on each user's abilities and shopping preferences. This further enables each user to earn reward activity-related reward points regardless of the individual's physical limitations and/or current fitness levels

The activity rewards generator in some examples utilizes customized user activity measures and customized minimum transaction thresholds for calculating activity-based rewards. Reward points are assigned to a user to incentivize shoppers to increase time spent in physical stores and/or increase a number of shopping trips to physical stores while discouraging loitering and preventing congestion in high-traffic areas of stores. This enables users to reach fitness goals and accomplish shopping tasks simultaneously. Users may also increase physical activity regardless of inclement weather.

In other examples, a route generation component generates a recommended route through a retail environment, which includes a path requiring an amount of activity to complete that satisfies the customized minimum activity threshold for the user. The recommended route may include a path through a store which includes items which the user may wish to purchase, a path through the store that is uncongested/unobstructed, and/or a path through the store that includes one or more new/promotional items. This enables the activity rewards generator to encourage traffic through desirable areas of the store without increasing congestion or creating crowded conditions in certain areas of the store. This further improves the user's experience within the retail environment.

A time-out component in other examples pauses measurement of a user's activity if the user leaves the retail environment prior to completing a selected transaction to purchase a set of one or more items. If the user returns to the retail environment within a threshold time-out period, an activity tracker resumes measurement of the user's activity. If the user fails to return to the retail environment within the threshold time-out period, the activity tracker resets a measurement or counter of activity for the user back to zero. This enables a user to exit a store for a brief period of time without losing credit for the number of steps or other activity already performed within the store. In this manner, the measurement of activity performed by the user within the store is measured with improved accuracy and reliability.

A customized minimum transaction threshold in other examples prevents inequitable threshold limits for users with less buying capability/smaller average basket size. In other words, the customized minimum transaction threshold is generated for each user based on each user's average transaction total and/or average basket size. This enables each user to have a unique minimum transaction amount which the user is likely to satisfy on a typical visit to the retail environment.

In these examples, a user may earn rewards if the user purchases a minimum number of items and/or the user purchases one or more items for a transaction total (purchase price) which is greater than or equal to a threshold amount. This incentivizes bona-fide shopper to reach fitness goals. The thresholds further discourage loitering by limiting rewards points which may be earned by users for a single day or other time-period.

The activity tracker in other examples integrates fitness tracking for incentivizing shoppers based on their physical activity in stores while limiting misuse of the rewards. This further improves shopper frequency and duration to improve sales retention in stores.

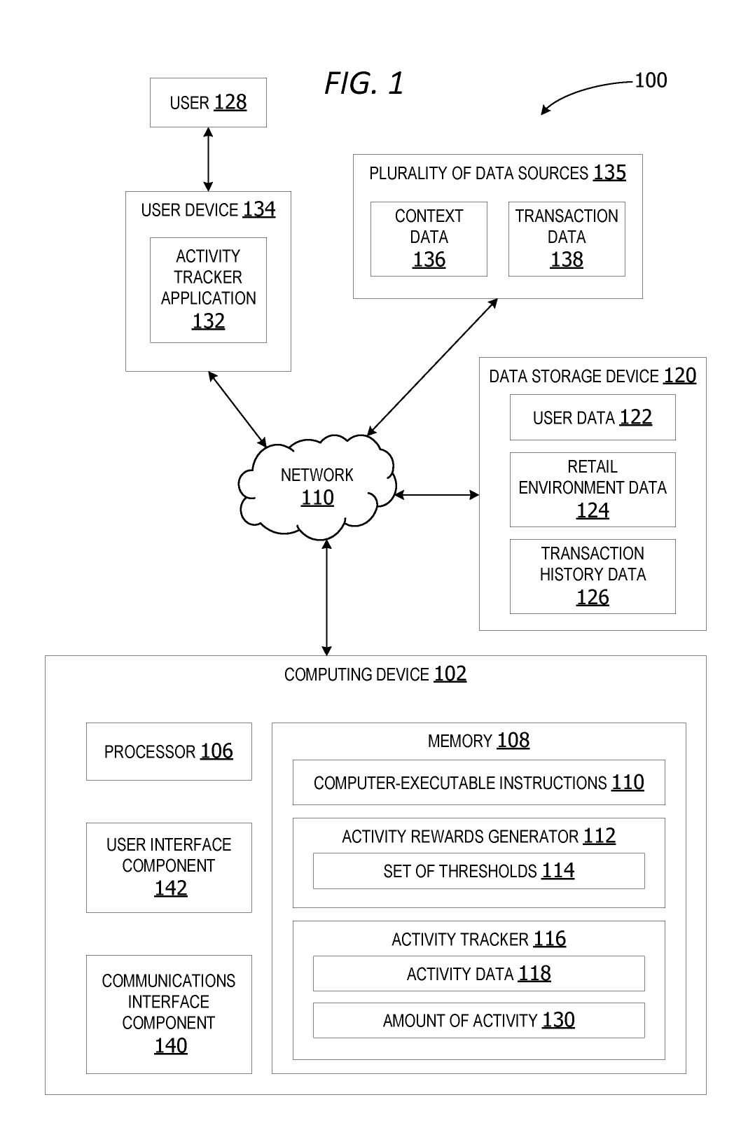

Referring again to FIG. 1, an exemplary block diagram illustrates a system 100 for activity-based reward generation. In the example of FIG. 1, the computing device 102 represents any device executing computer-executable instructions 104 (e.g., as application programs, operating system functionality, or both) to implement the operations and functionality associated with the computing device 102. The computing device 102 may include a mobile computing device or any other portable device. In some examples, the mobile computing device includes a mobile telephone, laptop, tablet, computing pad, netbook, gaming device, and/or portable media player. The computing device 102n may also include less portable devices such as desktop personal computers, kiosks, tabletop devices, industrial control devices, wireless charging stations, and electric automobile charging stations. Additionally, the computing device may represent a group of processing units or other computing devices. In this non-limiting example, the computing device 102 is implemented as a server or a kiosk associated with a retail environment.

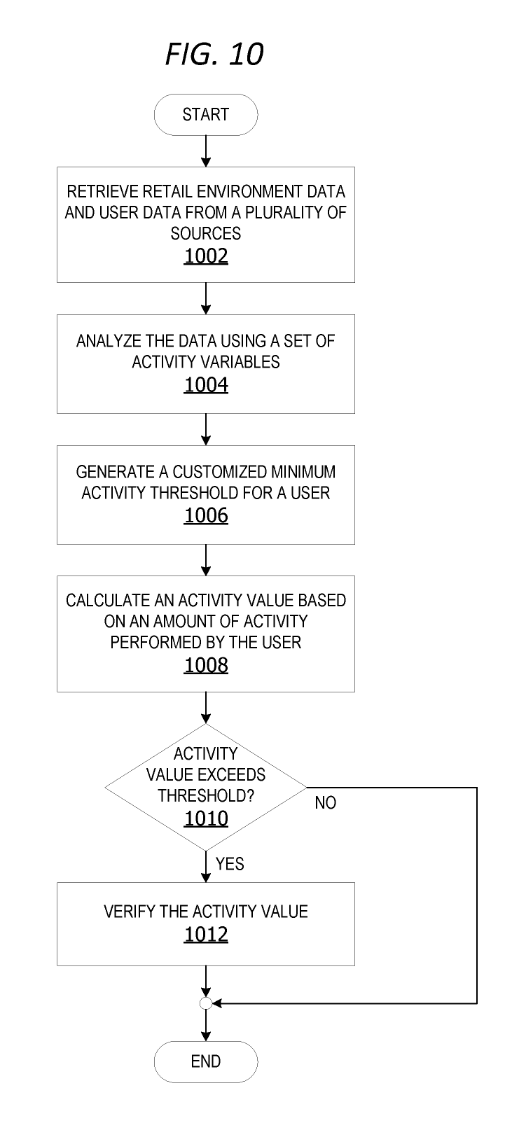

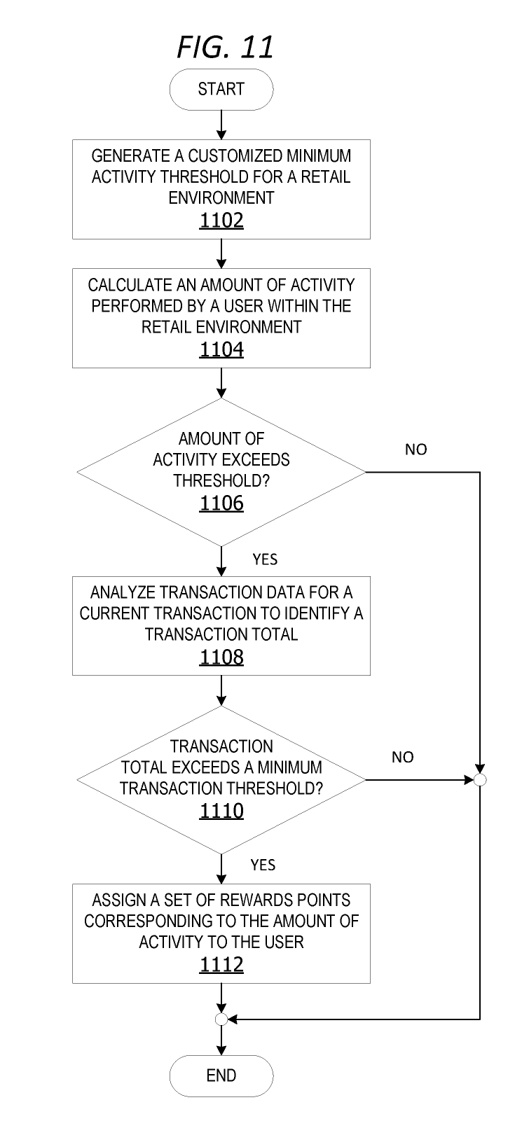

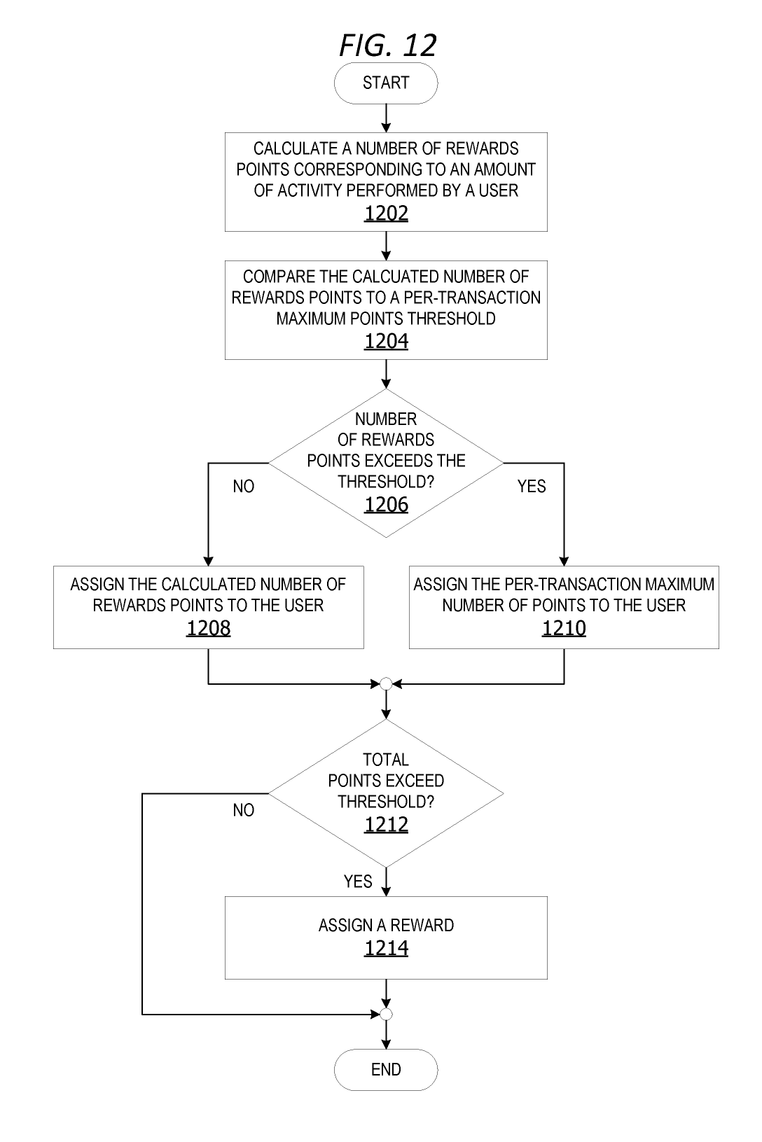

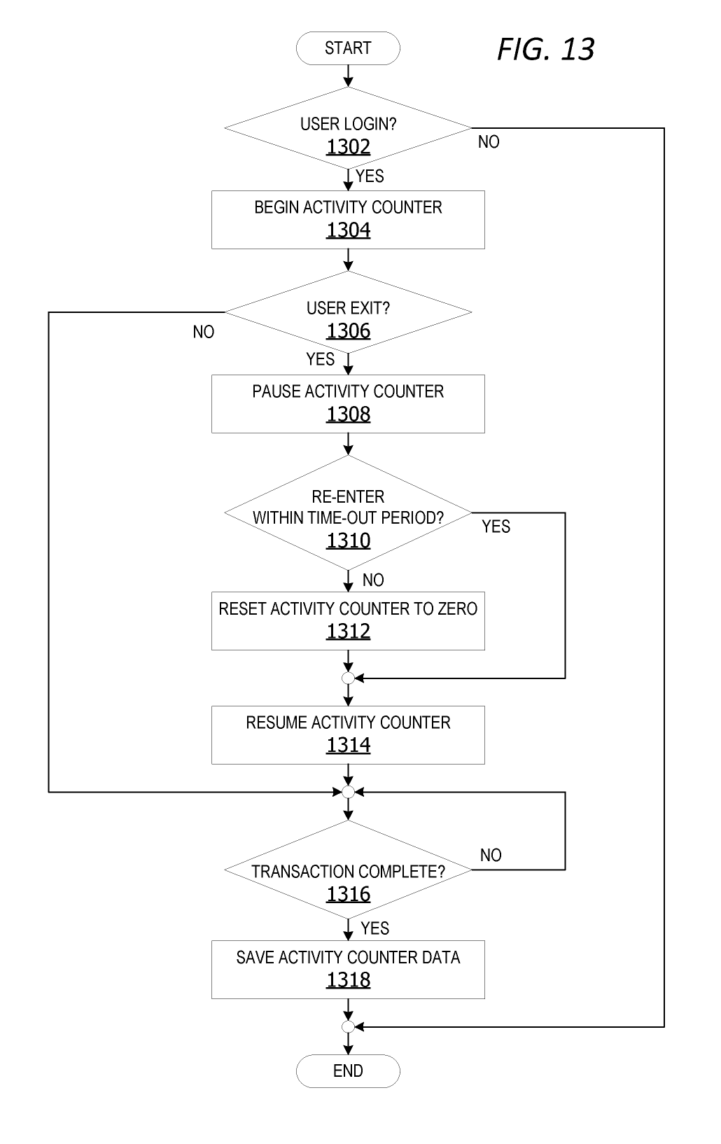

In some examples, the computing device 102 has at least one processor 106 and a memory 108. The processor 106 includes any quantity of processing units, and is programmed to execute the computer-executable instructions 104. The computer-executable instructions 104 may be performed by the processor 106 or by multiple processors within the computing device 102, or performed by a processor external to the computing device 102. In some examples, the processor 106 is programmed to execute instructions such as those illustrated in the figures (e.g., FIG. 10, FIG. 11, FIG. 12, and FIG. 13.

In some examples, the processor 106 represents an implementation of analog techniques to perform the operations described herein. For example, the operations may be performed by an analog computing device and/or a digital computing device.

The computing device 102 further has one or more computer readable media such as the memory 108. The memory 108 includes any quantity of media associated with or accessible by the computing device 102. The memory 108 may be internal to the computing device 102 (as shown in FIG. 1), external to the computing device (not shown), or both (not shown). In some examples, the memory 108 includes read-only memory and/or memory wired into an analog computing device.

The memory 108 stores data, such as one or more applications. The applications, when executed by the processor 106, operate to perform functionality on the computing device 102. The applications may communicate with counterpart applications or services such as web services accessible via a network 110. For example, the applications may represent downloaded client-side applications that correspond to server-side services executing in a cloud.

The network 110 is implemented by one or more physical network components, such as, but without limitation, routers, switches, network interface cards (NICs), and other network devices. The network 110 may be any type of network for enabling communications with remote computing devices, such as, but not limited to, a local area network (LAN), a subnet, a wide area network (WAN), a wireless (Wi-Fi) network, or any other type of network. In this example, the network is a WAN, such as the Internet. However, in other examples, the network 110 may be a local or private LAN.

The memory further stores one or more computer-executable components. Exemplary components include an activity rewards generator 112 for generating activity rewards points for users based on one or more threshold in a set of thresholds 114 and/or an activity tracker 116 for generating activity data 118.

The activity rewards generator 112, when executed by the processor 106 of the computing device 102, causes the processor 106 to generate a customized minimum activity threshold for a user 128 entering a retail environment based on user data 122, retail environment data 124 and/or transaction history data 126 associated with the user 128. Likewise, the minimum activity threshold may be customized for a particular user based on a time of day, a day of the week, month, season, holidays, occurrence of sporting events, or any other occurrence.

The activity rewards generator 112 in this example obtains the data from a remote data storage device 120 via the network 110. However, in other examples, the data may be stored locally on the computing device 102, stored on a cloud storage, or obtained from the plurality of data sources 135.

The activity tracker 116, when executed by the processor 106 of the computing device 102, causes the processor 106 to calculate an amount of activity 130 performed by the user 128 within the retail environment during a time-period between entering the retail environment and completing a selected transaction to purchase one or more items. The amount of activity 130 performed by the user may be calculated based on an analysis of activity data 118.

The activity data 118 is data generated by an activity counter measuring activity of a user, such as, but not limited to, a number of steps taken by the user 128. The activity data 118 in this example is generated by an activity tracker application 132 running on a user device 134 associated with the user 128. The activity tracker application 132 counts each step taken by a user. In other examples, the activity tracker application may measure other types of activity by the user 128, such as, but not limited to, arm movements, hand movements, head movements, torso movements, items lifted, or any other type of physical activity. The activity tracker application 132 in other examples obtains the activity data 118 from one or more other devices, such as a pedometer, accelerometer, GPS route tracking device, or other sensor for measuring physical activity.

The activity tracker application 132 transmits the activity data 118 to the activity tracker 116 running on the computing device 102 via the network 110. In other examples, the activity tracker 116 generates the activity data 118 based on an analysis of context data 136, including sensor data, received from one or more sensor devices in a plurality of data sources 135.

In some non-limiting examples, the activity tracker is triggered as soon as the user walks into the retail environment and switches to a store Wi-Fi. The Wi-Fi sensors detect the user device 134 entering the retail environment and exiting the retail environment (entry and exit from a store).

The user device 134 may be implemented as any type of computing device. In this example, the user device 134 is a mobile computing device, such as, but not limited to, a cellular telephone, a tablet computer, a smart watch, or any other type of mobile computing device.

The activity rewards generator 112 in other examples analyzes transaction data 138 associated with a current transaction to verify a transaction total exceeds a minimum transaction threshold. The transaction total is a total purchase price for all items purchased during a single transaction. If the transaction total exceeds the minimum transaction threshold, the activity rewards generator 112 assigns a set of rewards points corresponding to the amount of activity 130 to the user 128. If the total number of rewards points exceeds a minimum number of rewards points, the user may opt to redeem the rewards points for a reward.

In some examples, a customized reward is provided to a user based on physical activity/physical effort performed by the user within a store to increase the frequency and time spent by the user within the store. The reward points and/or customized reward incentivizes frequent and active shoppers within a physical store to ensure low-cost, high goodwill.

In other examples, the total number of rewards points assigned to a user within a given time-period may be limited by a threshold maximum number of rewards points. The threshold maximum number of rewards points may be, for example, twenty-five points per day where a user is required to obtain one-hundred points prior to achieving a reward. In another non-limiting example, the threshold maximum number of points may be ten points per hour or fifteen points within a twenty-four-hour time-period. The threshold maximum number of rewards points places a cap on the number of rewards points assigned to a given user to discourage users from loitering within a store after shopping is completed.

The reward may include one or more free items, a discount on a purchase price of one or more items, a coupon, a percentage discount on a transaction total for a next transaction, a gift cart, or any other type of reward. The reward in some examples is customized for the user 128. For example, if the user frequently purchases dog food or other dog-related pet supplies, the reward may be a pet-care item for a dog, such as dog toys, dog grooming items, dog food, etc. In another example, if a user frequently purchases baby items, the reward may include a baby food items, baby clothing items, baby toys, diapers, baby wipes, etc.

The data storage device 120 may include a set of one or more data storage devices storing data, such as, but not limited to, user data 122, retail environment data 124, and/or transaction history data 126 associated with one or more users. The user data 122 includes data provided by a user. The user data 122 may include a user account, user device data, a set of user preferences, user purchase history, a user's preferred activity type, an activity type assigned to the user, etc.

The retail environment data 124 is data describing a retail environment, such as a store. The retail environment data 124 may include a location of items in the store, a layout of the store, a size/dimensions of the store in square feet or square meters, current inventory, expiration date of perishable items in inventory, and so forth. In one non-limiting example, some brick-and-mortar stores may include shopping areas ranging from 18,000 square meters to 24,000 square meters, or more. This provides ample indoor space for users to walk and achieve fitness goals regardless of inclement weather.

The transaction history data 126 is data describing one or more transactions by the identified user occurring in the past, such as transactions that occurred during a predetermined time-period in the past. For example, the transaction history data 126 may include a list of all items purchased by the identified user within the last six months or within the last year. The transaction history data may include historical data for a plurality of transactions by a single user, as well as transactions by a plurality of users.

The transaction history data 126 includes data describing a transaction total (amount paid) during one or more transactions. The transaction history data 126 may optionally also include an average transaction total for each transaction completed by the identified user. The average transaction total may be calculated as:

$$Average Transaction Total = \frac{Transaction Totals for N transaction}{N}$$

where the sum of all transaction totals in an “N” number of transactions is divided by the total number “N” of all transactions to obtain the average transaction total for a particular user.

The average transaction total may be utilized to generate a minimum transaction threshold in some examples. The transaction history data 126 may optionally also include a shopping duration for each transaction and/or an average transaction duration for the user as:

$$Average Transaction Duration = \frac{Total Duration of N transactions}{N}$$

Where the average transaction duration may be calculated as the sum of the duration of all transaction in an “N” number of transactions divided by the total number “N” of transactions to obtain the average transaction duration time. This average transaction duration time may be utilized by the threshold generator to create a customized per-user minimum activity threshold.

In still another example, the transaction history data may include a type of items purchased by the user. A type of items purchased is a classification or category for one or more items. An exemplary type may include salad dressing, condiments, organic foods, low-fat foods, sugar-free foods, exercise equipment, sports-related items, etc.

The data storage device may include one or more types of data storage devices, such as, for example, one or more rotating disks drives, one or more solid state drives (SSDs), and/or any other type of data storage device. The data storage device in some non-limiting examples includes a redundant array of independent disks (RAID) array. In other examples, the data storage device includes a database.

The computing device 102 may optionally include a communications interface component 140. In some examples, the communications interface component 140 includes a network interface card and/or computer-executable instructions (e.g., a driver) for operating the network interface card. Communication between the computing device 102 and other devices may occur using any protocol or mechanism over any wired or wireless connection. In some examples, the communications interface component 140 is operable with short range communication technologies such as by using near-field communication (NFC) tags.

In other examples, the computing device 102 may optionally include a user interface component 142. In some examples, the user interface component 142 includes a graphics card for displaying data to the user and receiving data from the user. The user interface component 142 may also include computer-executable instructions (e.g., a driver) for operating the graphics card. Further, the user interface component 142 may include a display (e.g., a touch screen display or natural user interface) and/or computer-executable instructions (e.g., a driver) for operating the display. The user interface component 142 may also include one or more of the following to provide data to the user or receive data from the user: speakers, a sound card, a camera, a microphone, a vibration motor, one or more accelerometers, a BLUETOOTH brand communication module, global positioning system (GPS) hardware, and a photoreceptive light sensor. For example, the user may input commands or manipulate data by moving the computing device in a particular way.

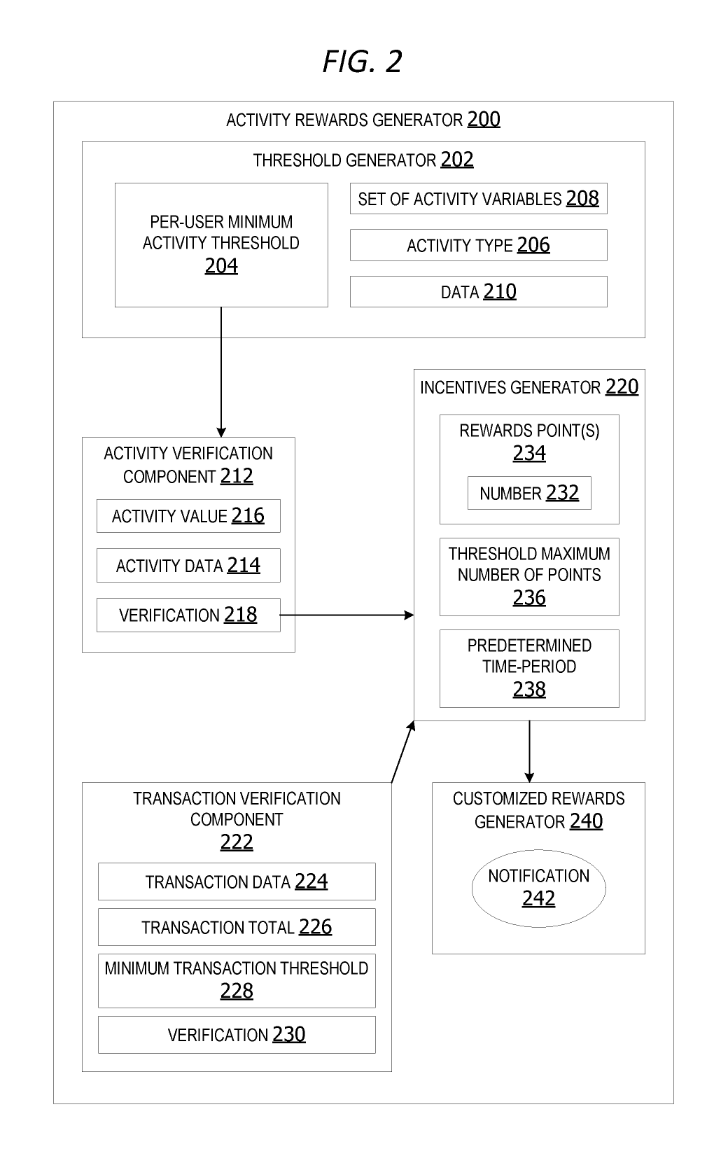

FIG. 2 is an exemplary block diagram illustrating an activity rewards generator 200. The activity rewards generator 200 is a component executing on a computing device, such as the computing device 102 in FIG. 1. A threshold generator 202 generates a per-user minimum activity threshold 204 and activity type 206 based on an analysis of data 210 using a set of activity variables 208.

The set of activity variables 208 in some examples may include a type of store. The type of store may be a grocery store, supercenter, hardware store, etc. The set of activity variables 208 may also include store size, average basket-size for the store, day of the week, and/or time of the day.

The minimum activity threshold may include a threshold for measuring steps taken by a user, a threshold for measuring arm movements, or a threshold for measuring any other alternative activity type. In some non-limiting examples, the per-user minimum activity threshold includes a minimum number of steps and/or a maximum number of steps. If the user performs a number of steps that is less than the minimum number of steps, the user fails to receive reward points. The activity tracker in other examples, stops counting the user's steps when the number of steps taken by the user is equal to the maximum number of steps. In other words, the maximum number of steps is a cap or upper threshold limit for activity which is eligible for earning rewards.

The activity type 206 is an activity performance indicator used for calculating an amount of physical activity performed by a user. The activity type 206 may also be any type of physical activity utilized to measure activity by a user for purposes of calculating reward points. Other factors used to calculate reward points may include, without limitation, a route taken by the user through the store, an area traversed by the user, a number of aisles passed, day of the week, time of the day, holidays, number of items purchased, frequency of visits to the store, consecutive days the store is visited by the user, etc.

For example, fewer reward points may be awarded on weekends when the store has greater traffic/congestion and more reward points may be awarded on weekday mornings when the store has less traffic/uncongested. Likewise, more reward points may be awarded to users that walk in uncongested/low-traffic areas while fewer reward points may be given to users that walk through crowded aisles/visit high-traffic areas of the store.

In some examples, the activity type 206 is a number of steps taken inside a store or other retail environment. In other examples, if a user is disabled, the activity type may be an alternative type of performance indicator to quantify their shopping efforts, such as, but not limited to, head movements, arm movements, torso movements, etc. The amount of activity performed by a disabled user may be calculated based on one of these alternative activity performance indicator/activity types.

The activity verification component 212 analyzes data 210 to calculate the amount of activity performed. The data 210 may include any type of data associated with a user, a retail environment, and/or a plurality of transactions. For example, the data 210 may include context data describing a real-time environment within a retail store, user data for an identified user, and/or transaction history data.

An activity verification component 212 analyzes activity data 214 to determine an amount of activity performed by a user during a given shopping trip. The activity data 214 is data generated by an activity tracker, such as the activity tracker application 132 or the activity tracker 116 in FIG. 1. The activity data 214 may be received from a user device associated with the user, an activity tracker device, such as a pedometer, and/or a set of sensor devices associated with the retail environment.

The activity verification component 212 analyzes the activity data 214 to verify an activity value 216 exceeds the per-user minimum activity threshold for the activity type 206. The activity value represents the amount of activity performed by the user prior to completion of a selected transaction during a single shopping trip. In this non-limiting example, if the activity value 216 exceeds the per-user minimum activity threshold, the activity verification component 212 sends a verification 218 to an incentives generator 220.

A transaction verification component 222 analyzes transaction data 224 to determine whether a transaction total 226 for the selected transaction exceeds a minimum transaction threshold 228. The transaction data 224 is data identifying one or more items purchased by the user and/or the purchase price for each item purchased. The transaction data 224 may also include the transaction total 226. The transaction total 226 is the total purchase price for all items purchased in a single transaction.

The transaction data 224 may be generated by one or more point of sale (POS) devices within the retail environment on completion of the transaction by the identified user. In other examples, the transaction data 224 may be generated by the user device. The transaction verification component 222 sends a verification 230 to the incentives generator 220 if the transaction total 226 exceeds the minimum transaction threshold 228.

The minimum transaction threshold 228 may be a predetermined, user-defined threshold value. In other examples, the threshold generator 220 generates a customized minimum transaction threshold 228 for a given retail environment. In other words, the minimum transaction threshold 228 may be a per-user threshold value generated for a specific retail store, based on the size of the store, the location of the store, average transaction totals for the store, average basket size for the store, etc. The basket size is the number of items purchased during a single transaction/shopping trip.

The threshold generator 202 generates a per-user customized minimum transaction threshold 228 for each user in other examples. In other words, each user may have a different, unique minimum transaction threshold based on that particular user's average transaction total, average basket size, etc. Likewise, the minimum transaction threshold may be customized for a particular user based on a time of day, a day of the week, month, season, holidays, occurrence of sporting events, or any other occurrence. For example, average basket size may increase during the week prior to Thanksgiving. During this time a maximum transaction threshold may be increased. Likewise, average basket size may decrease during the week immediately following Thanksgiving. During this time, the minimum transaction threshold may be decreased. Thus, changing transaction trends may be considered for generation of customized transaction thresholds.

The transaction threshold may include a minimum transaction threshold and a maximum transaction threshold for a particular user. The minimum transaction threshold is a minimum basket size which the user transaction must meet before the transaction will be eligible for activity rewards. A minimum basket size may refer to a minimum number of items purchases and/or a minimum dollar amount/purchase price for one or more items purchased during a single transaction/single shopping trip.

In some examples, the maximum transaction threshold is a maximum basket size qualifying for activity rewards. The amount of activity and transaction total may be considered when calculating a number of reward points assigned to the user until the transaction total reaches the maximum transaction threshold. After the maximum transaction threshold, in some examples, additional items purchased and/or additional transaction amounts exceeding the threshold are not considered when calculating the rewards points.

The maximum basket size may be varied based on an amount of activity/number of steps performed by a user. Likewise, the maximum activity threshold for a user may be varied based on the basket size/transaction total. For example, a first maximum activity threshold may be applied to transaction within a first bucket-size range, a second, higher maximum activity threshold may be applied to a transaction falling within a second bucket-size range, and a third maximum activity threshold may be applied to a third bucket-size range.

An incentives generator 220 assigns a number 232 of reward points 234 to the identified user on condition the transaction total 226 exceeds the minimum transaction threshold 228 and the activity value 216 exceeds the per-user minimum activity threshold 204 prior to completion of the transaction and the transaction total 226 exceeds the minimum transaction threshold 228.

If the number 232 of reward points 234 exceeds a threshold maximum number of points 236 for a predetermined time-period 238, the threshold maximum number of points 236 are assigned to the user. In other examples, if the threshold maximum number of points 236 exceeds the number 232 of reward points calculated for the user based on the activity value 216, the number 232 of reward points 234 is assigned to the user.

In one non-limiting example, if the user walks 3000 steps and spends $30 dollars on a single transaction, the incentives generator assigns ten points to the user's reward points account. The reward points 234 assigned to the user may be set to expire after a predetermined time-period to ensure continued efforts by users. For examples, accumulated reward points may expire every year or every two-years.

In some examples, the reward points are saved in a user rewards account. When the number of points in the rewards account reaches a minimum number, the user may redeem the points for a reward. A customized rewards generator 240 may optionally send a rewards notification 242 indicating the user may redeem rewards points for a customized award if a total number of reward points assigned to the user exceeds a threshold number of rewards points. The user may redeem reward points to obtain a reward during the current transaction or during a future transaction.

The rewards notification 242 in some examples includes a notification of a rewards item assigned to the user, such as, but not limited to, a free item. In other examples, the notification includes a recommendation of two or more items available for redemption as a reward. In this non-limiting example, the user may select one of the two or more items to be redeemed as a reward if the user has collected the prerequisite minimum number of reward points for reward redemption

In some examples, the activity tracker count steps until the user while the user is inside a store to measure the true physical effort spent during shopping. The activity tracker may include a maximum threshold for steps or other activity which is recorded in a single trip. A minimum transaction limit in these examples is set for physical activity, which may be taken to be as:

Average Basket Size=Total Basket size/Number of trips

This minimum transaction limit is computed as the amount of average basket size per trip for most recent 12 months' data. Once checkout and payment for purchased items occurs, the activity tracker stops counting steps or other activity. Therefore, loitering after checkout does not increase the amount of activity calculated for purposes of obtaining rewards.

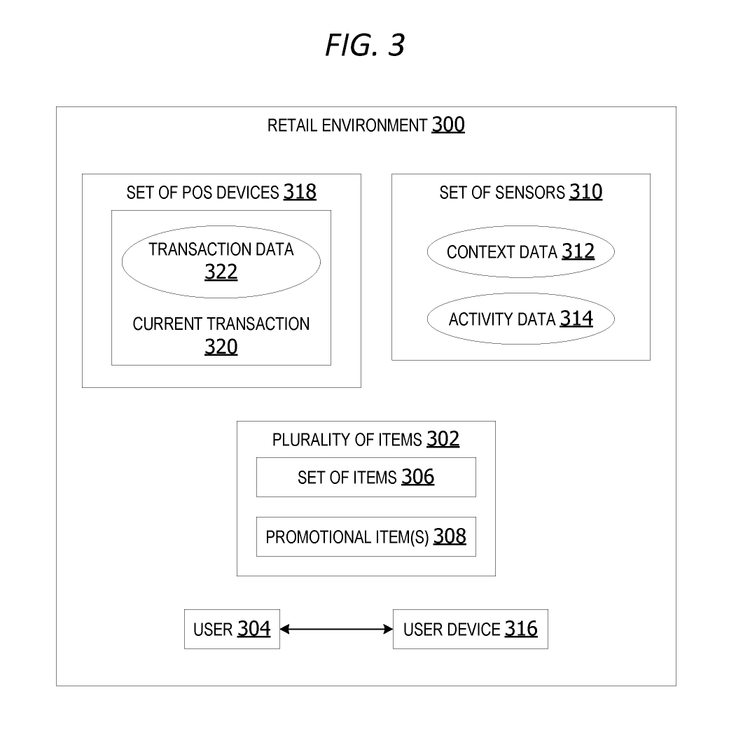

FIG. 3 is an exemplary block diagram illustrating a retail environment 300. The retail environment 300 in some examples is a retail store or other retail location. The retail environment 300 may include a plurality of items 302 available for purchase by one or more users, such as user 304. In this example, the user 304 purchases a set of items 306 including at least one item.

The plurality of items 302 may also include one or more promotional item(s) 308. A promotional item may include a new item recently added to inventory. In other examples, a promotional item may include an item on sale.

In some examples, when the user 304 is detected entering the retail environment, such as through an entrance or other door into a store, a set of sensors 310 generates context data 312 associated with real-time conditions within the retail environment and/or activity data 314 associated with actions or activities performed by the user 304. In other examples, the activity data 314 is generated by a user device 316 associated with the user, such as a pedometer or other activity tracking device.

The user 304 in some examples completes a current transaction 320 via one or more POS devices in a set of POS devices 318 within the retail environment. The set of POS devices 318 generates transaction data 322 describing the current transaction 320. The transaction 322 identifies a transaction total, item(s) purchased in the transaction, date and time of the transaction, as well as any other data associated with the current transaction 320.

In other examples, the transaction data 322 is generated by the user device 316. In other words, the user may complete the current transaction 320 via an application running on the user device instead of using a POS device. The transaction data is sent to a transaction verification component to determine whether the user qualifies for reward points.

In one non-limiting example, after activity data is calculated it is recorded in a user account and/or transmitted to a user device. After the physical activity data has been recorded, the user automatically receives reward points linked to the amount of activity if the user completes the minimum threshold of ‘a’ number of steps in one trip and a minimum transaction of ‘n’ dollars. In this example, for every ‘a’ steps taken, the user receives ‘x’ points. This ‘a’ will vary for each store/retail environment based on the store area. In one non-limiting example, for a store of 20,000 sq. m, a minimum effort of walking 2500 steps leads to a gain of 10 points.

These minimum ‘a’ steps for a store is calculated by considering that on an average, a user spends at least ‘c’ minimum walking hours in a store on a single trip. For example, the average shopper duration for a supercenter may be one hour for a single trip. In this example, a user may take around 40 steps in a single minute. This translates to an average of 2400 steps taken inside a supercenter during the one-hour time-period. These points accumulate until it reaches a specific ‘y’ points, after which the points may be redeemed for a reward item.

In some examples, the user selects a reward to redeem from a predetermined basket of one or more reward items. This basket of goods will be optimized such that it includes items in spare inventory, items approaching an expiration date, promotional items, and/or items preferred by the user. This promotes wellness and fitness among shoppers while promoting items for rewards which are spare to assist in pulling down activity-rewards related costs.

The set of sensors 310 in this example is a set of one or more sensor devices. The set of sensor devices 310 may include one or more image capture devices, microphones, pressure sensors, radio frequency identification (RFID) tag readers, barcode readers, and/or any other type of sensors for generating context data 312 and/or activity data 314. The set of sensors 310 may be included within a plurality of data sources, such as the plurality of data sources 135 in FIG. 1.

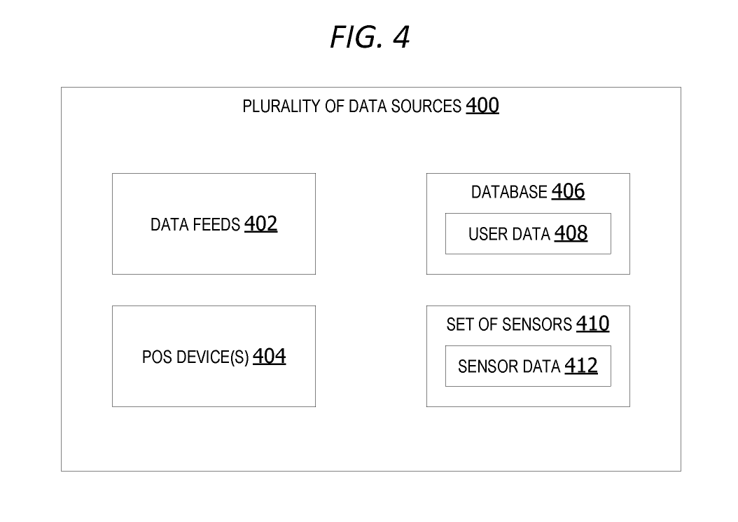

FIG. 4 is an exemplary block diagram illustrating a plurality of data sources 400. The plurality of data sources 400 includes one or more sources of context data and/or activity data, such as, but without limitation, the plurality of data sources 135 in FIG. 1 and/or the set of sensors 310 in FIG. 3.

In some examples, the plurality of data sources 400 includes one or more data feeds 402. Data feeds 402 may include news feeds, weather service feeds, as well as any other type of information feeds. The data feeds 402 may be received via a network, such as the network 110 in FIG. 1.

POS device(s) 404 may include one or more POS device(s) for completing at least one transaction. The POS device(s) 404 may be implemented as a POS device, such as the set of POS devices 318 in FIG. 3. The POS device(s) 404 in this example generate transaction data associated with a transaction associated with a shopping trip.

The plurality of data sources 400 may optionally include a database storing data, such as, but not limited to, user data 408. The user data 408 may include data such as user data 122 in FIG. 1. The database 406 may be implemented as a relational database, a filesystem, or any other type of datastore associated with a data storage device, such as the data storage device 120 in FIG. 1.

A set of sensors 410 may optionally be included in the plurality of data sources 400 for generating sensor data 412 associated with activity performed by the user within the retail environment and/or context data associated with current conditions within the retail environment. For example, the sensor data 412 may include camera data identifying a number of steps taken by a user and/or a route through the retail environment traversed by the user during a single shopping trip associated with a current transaction.

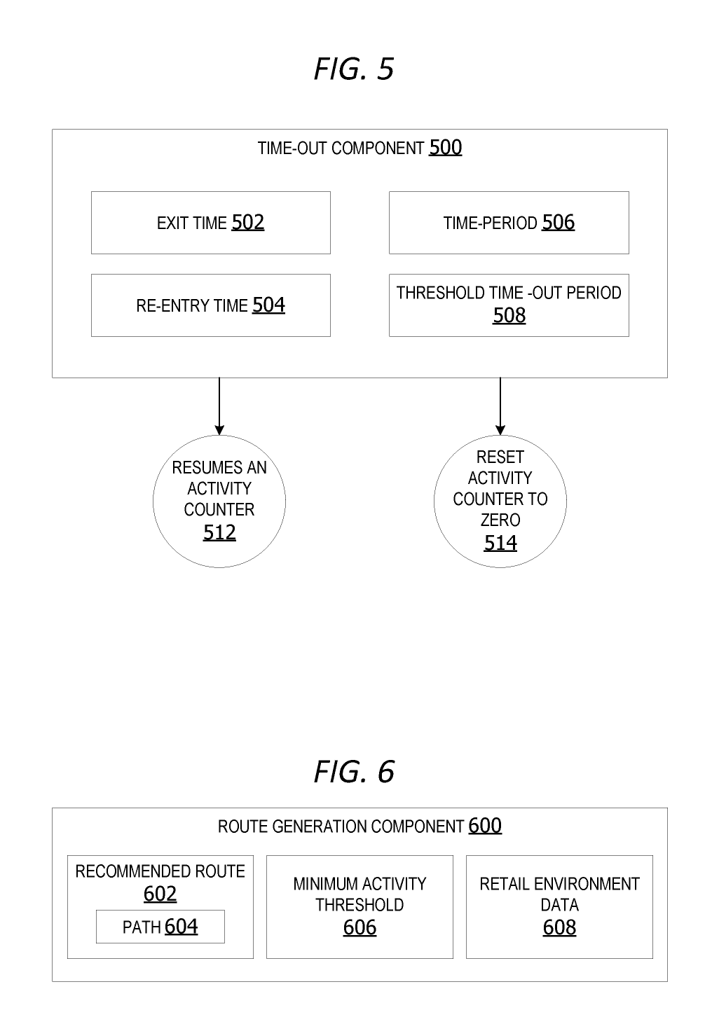

FIG. 5 is an exemplary block diagram illustrating a time-out component 500. The time-out component pauses measurement of activity of a user in response to detecting the user exiting the retail environment. For example, if the user goes out an exit door leading into a parking area of a retail store, the time-out component 500 stops the activity counter at an exit time 502. The exit time 502 is the time at which the user leaves the retail store. The re-entry time 504 is the time the user re-enters the retail environment. The re-entry time is the time when the use re-enters the retail store through an entrance or door. If the time-period 506 between the exit time 502 and the re-entry time 504 exceeds a threshold time-out period 508, the time-out component 500 resumes an activity counter 512. Resuming the activity counter 512 refers to continuing to measure activity of the user where the counter left off at the exit time 502. In other words, when the user re-enters the store, the user's previous activity prior to exiting the store at the exit time 502 is preserved/included in the amount of activity for the current shopping trip/transaction.

If the time-period 502 between the exit time 502 and the re-entry time 504 exceeds the threshold time-out period 508, the activity counter is re-set to zero 514 by the time-out component 500. When the user re-enters the store, the user's previous activity prior to exiting the store at the exit time 502 is disregarded/lost.

In one example, if the user exits a store or other retail environment for any reason, the activity tracker stops/pauses the step count as soon as the customer is disconnected from the Wi-Fi. For temporary disconnections, if the user reenters the store and connects back to store Wi-Fi within the timeout period, the activity tracker resumes counting steps/other activity.

FIG. 6 is an exemplary block diagram illustrating a route generation component 600. The route generation component 600 generates a recommended route 602 for the identified user. The recommended route 602 includes a path 604 through the retail environment which satisfies a minimum activity threshold 606 for a user if the route is completed.

The path 604 in some examples is a path that excludes a congested/crowded area, high traffic areas, areas requiring maintenance, areas having a wet floor surface, and/or areas having obstructed access. In other examples, the recommended route includes a path 604 through the retail environment that includes an area of the retail environment frequented by the identified user, an area of the retail environment including items previously purchased by the user, and an area of the retail environment including promotional items of potential interest to the user.

The recommended route 602 may be generated based on retail environment data 608, context data associated with current conditions within the retail environment, user preference data, and/or transaction history data. The context data may include a time of day, a day of the week, month, season, holidays, occurrence of sporting events, or any other occurrence. For example, a recommended route through a store at 10:30 a.m. on a weekday when the store is quiet/uncongested may be a longer/different route than the recommended route through the store at 5:30 p.m. on a weekday when the store is busy/more congested.

Likewise, a recommended route 602 through a store may avoid grocery areas the day before Thanksgiving when grocery aisles are congested with larger numbers of shoppers than normal. The recommended route 602 in August may include route past aisles of school supplies in anticipation of increased interest in back-to-school supply purchases.

The context data may be received from a plurality of data sources in real-time. In other examples, the route generation component 600 generates the recommended route 602 based on at least one of a set of user preferences and user transaction history data.

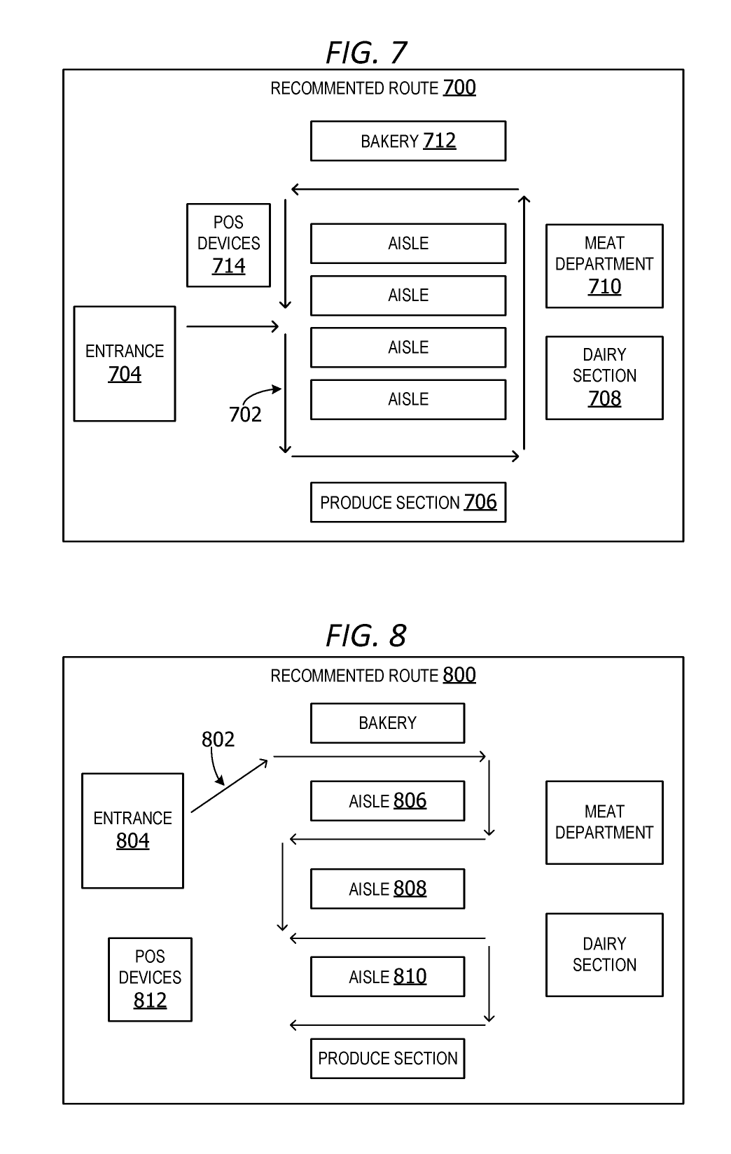

FIG. 7 is an exemplary block diagram illustrating a recommended route 700. The recommended route 700 in this non-limiting example is output to a user device associated with a user in a retail environment. The recommended route 700 includes a path 702 beginning at an entrance 704 of the retail environment, winding around a circumference of the retail environment passing by a produce section 706, dairy section 708, meat department 710, bakery 712, and ending at one or more POS devices 714.

FIG. 8 is an exemplary block diagram illustrating another recommended route 800. The recommended route 800 in this non-limiting example includes a path 802 beginning at an entrance 804 of the retail environment and winding around a set of one or more aisles. In this example, the set of aisles includes aisle 806, 808, and 810. The path 802 ends at one or more POS devices 812 where the user completes a transaction.

In some examples, the system verifies the user has completed the recommended route prior to completing a transaction based on GPS data generated by a GPS-based route tracker. In other examples, the system verifies the user completes the recommended route via image data generated by one or more cameras. The image data is analyzed using video analytics to confirm the user completes the recommended route.

In yet another example, the system verifies the user completes the recommended route via a user device connected to a store Wi-Fi. The user is detected entering the store when the user device connects to the store Wi-Fi and the user is detected leaving the store when the user device disconnects from the store Wi-Fi. If the user fails to complete the recommended route, the system calculates the amount of activity performed, such as number of steps, and confirms the amount of activity meets or exceeds the minimum activity threshold.

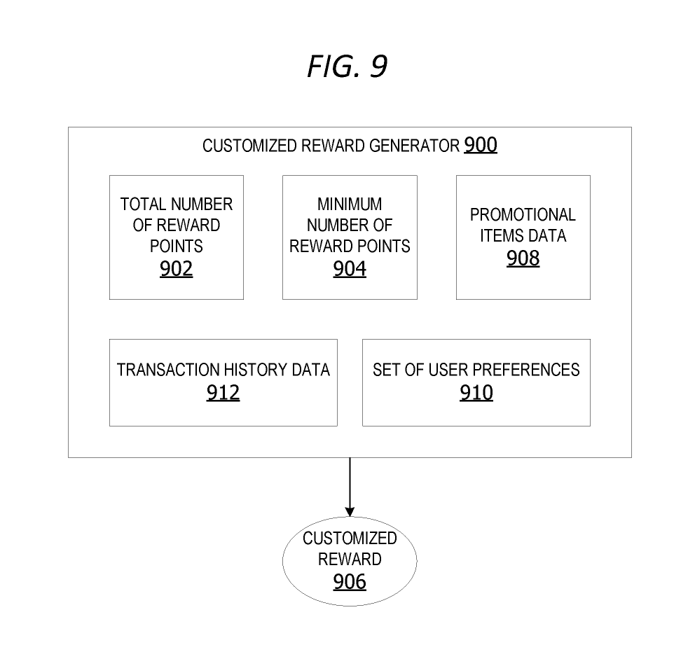

FIG. 9 is an exemplary block diagram illustrating a customized reward generator 900. The customized reward generator 900 compares a total number of reward points 902 with a minimum number of reward points 904 to receive a reward. If the total number of reward points 902 equals or exceeds the minimum number of reward points 904, the customized reward generator 900 generates a customized reward for the user.

The customized reward 906 may be selected based on promotional items data 908. The promotional items data 908 identifies one or more items being promoted by a store. A promotional item may be selected as a reward for the user based on a set of user preferences 910 provided by the user and/or transaction history data 912 identifying items previously purchased by the user. In other words, the set of user preferences 910 and the transaction history data 912 may be utilized to determine which promotional item is likely to be of the most interest to the user.

FIG. 10 is an exemplary flow chart illustrating operation of the computing device to verify an activity value based on a customized minimum activity threshold for a user. The process shown in FIG. 10 may be performed by an activity rewards generator executing on a computing device, such as, but not limited to, the computing device 102 in FIG. 1.

The process begins by retrieving retail environment data and user data from a plurality of sources at 1002. The data may be obtained from a one or more data sources, such as the plurality of data sources 135 in FIG. 1, the data storage device 120 in FIG. 1, the set of sensors 310 in FIG. 3, and/or the plurality of data sources 400 in FIG. 4.

A threshold generator analyzes the data using a set of activity variables at 1004. The threshold generator is a component for generating one or more per-user thresholds, such as the threshold generator 202 in FIG. 2. A customized minimum activity threshold is generated for a user at 1006, such as the per-user minimum activity threshold 204 in FIG. 2. An activity value is calculated based on an amount of activity performed by the user at 1008. The activity value is a value quantifying an amount of activity performed by the user, such as, the activity value 216 in FIG. 2.

An activity verification component determines if the activity value exceeds a threshold at 1010. The activity verification component is a component such as, but not limited to, the activity verification component 212 in FIG. 2. The threshold in some examples is a customized minimum activity threshold, such as the per-user minimum activity threshold 202 in FIG. 2 or the minimum activity threshold 606 in FIG. 6. If no, the process terminates thereafter.

If the activity value exceeds the threshold at 1010, the activity value is verified at 1012. The process terminates thereafter.

While the operations illustrated in FIG. 10 are performed by a server or other computing device, aspects of the disclosure contemplate performance of the operations by other entities. For example, a cloud service may perform one or more of the operations.

FIG. 11 is an exemplary flow chart illustrating operation of the computing device to assign reward points based on a customized minimum activity threshold and a customized minimum transaction threshold. The process shown in FIG. 11 may be performed by an activity rewards generator executing on a computing device, such as, but not limited to, the computing device 102 in FIG. 1.

The process begins by generating a customized minimum activity threshold for a retail environment at 1102. An amount of activity performed by a user within the retail environment is calculated by an activity verification component at 1104. The activity verification component may be implemented as a component such as the activity verification component 212 in FIG. 2. The activity verification component determines if the amount of activity exceeds a threshold at 1106. If no, the process terminates thereafter.

If the amount of activity exceeds the threshold at 1106, a transaction verification component, such as the transaction verification component 222 in FIG. 2, analyzes transaction data for a selected transaction to generate a transaction total at 1108. The transaction verification component determines whether a transaction total exceeds a minimum transaction threshold at 1110. If no, the process terminates thereafter.

If the selected transaction total exceeds the threshold at 1110, an incentives generator assigns a set of reward points corresponding to the amount of activity to the user at 1112. The incentives generator is a component such as the incentives generator 220 in FIG. 2. The process terminates thereafter.

While the operations illustrated in FIG. 11 are performed by a server or other computing device, aspects of the disclosure contemplate performance of the operations by other entities. For example, a cloud service may perform one or more of the operations.

FIG. 12 is an exemplary flow chart illustrating operation of the computing device to assign a customized reward to a user. The process shown in FIG. 12 may be performed by an activity rewards generator executing on a computing device, such as, but not limited to, the computing device 102 in FIG. 1.

The process begins by an incentives generator calculating a number of reward points corresponding to an amount of activity performed by a user at 1202. The incentives generator compares the calculated number of reward points to a per-transaction maximum points threshold at 1204. The incentives generator determines whether the number of rewards points exceeds the threshold at 1206. If no, the incentives generator assigns the calculated number of reward points to the user at 1208. If yes, the incentives generator assigns the per-transaction maximum number of reward points to the user at 1210.

A customized rewards generator determines whether the total points assigned to the user exceeds a threshold at 1212. The customized rewards generator is a component for generating customized rewards for a user, such as the customized rewards generator 240 in FIG. 2. If no, the process terminates thereafter. If the total number of points assigned to the user exceeds the threshold number of points at 1212, the customized rewards generator assigns a reward to the user at 1214. The process terminates thereafter.

While the operations illustrated in FIG. 12 are performed by a server or other computing device, aspects of the disclosure contemplate performance of the operations by other entities. For example, a cloud service may perform one or more of the operations.

FIG. 13 is an exemplary flow chart illustrating operation of the computing device to track user activity within a retail environment. The process shown in FIG. 13 may be performed by an activity tracker executing on a computing device, such as, but not limited to, the computing device 102 in FIG. 1.

The process begins by determining if a user log-in is received at 1302. If yes, a counter begins measuring activity by a user at 1304. A time-out component determines whether the user exits a retail environment at 1306. If yes, a time-out component pauses the activity counter at 1308. The time-out component may be implemented as the time-out component 500 in FIG. 5.

The time-out component determines whether the user re-enters the retail environment within a time-out period at 1310. If no, the time-out component resets the activity counter to zero at 1312.

If the user re-enters the retail environment within the time-out period, the time-out component resumes the activity counter without resetting it to zero at 1314. The time-out component determines whether a selected transaction is complete at 1316. If yes, activity counter data is saved at 1318. The process terminates thereafter.

Returning to operation 1306, if the user does not exit the retail establishment, the activity tracker determines whether a selected transaction is complete at 1316. If yes, the activity tracker stops the activity counter and saves the activity counter data at 1318. In some examples the activity counter data is saved as activity data in a data storage device. In other examples, the activity data is saved/recorded into the activity tracker application running on a user device associated with the user. The process terminates thereafter.

While the operations illustrated in FIG. 13 are performed by a server or other computing device, aspects of the disclosure contemplate performance of the operations by other entities. For example, a cloud service may perform one or more of the operations.

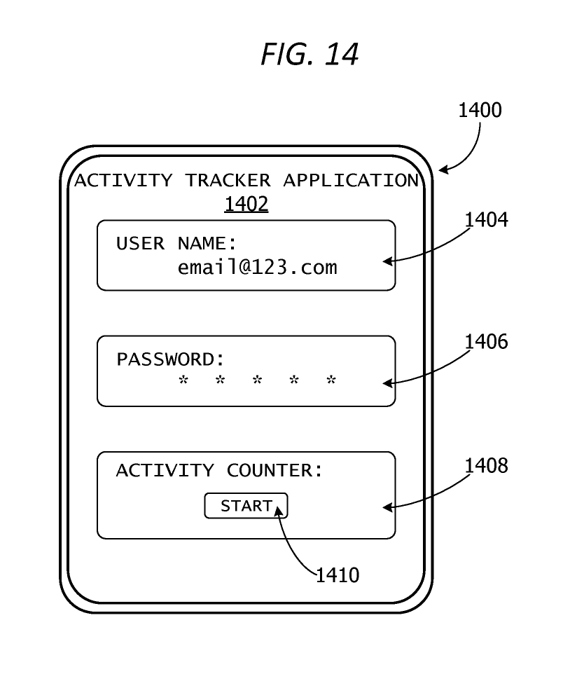

FIG. 14 is an exemplary block diagram of an activity tracker application log-in screen 1400. The activity tracker application 1402 includes a user log-in. In this non-limiting example, the user logs-in by entering a user name 1404 and password 1406. Upon log-in, an activity counter 1408 starts 1410. The activity counter generates activity data associated with activity performed by a user in the retail environment, such as, but not limited to, a number of steps taken by the user. In other examples, the activity counter may measure calories burned by the user during activity performed in the retail environment.

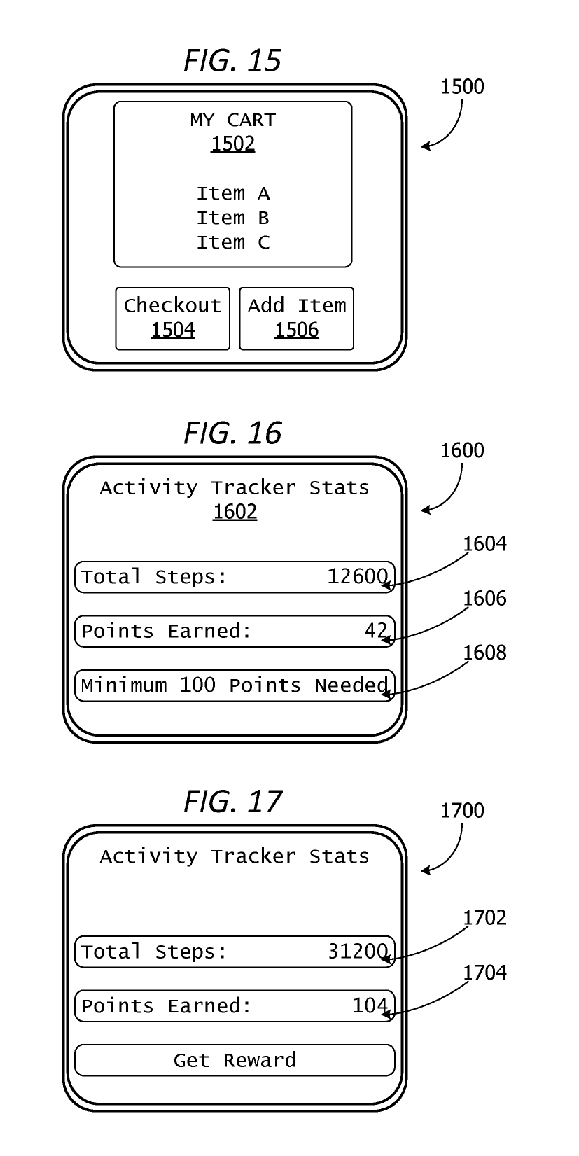

FIG. 15 is an exemplary block diagram of an activity tracker application cart contents screen 1500 displayed to a user on a user device, such as the user device 134 in FIG. 1. The screen 1500 may include contents 1502 of a cart. In this non-limiting example, the cart includes three items. In other examples, the user's cart of items to be acquired during a selected transaction may include a single item, as well as two or more items. The user may select to checkout 1504 or add an item 1506 to the cart.

FIG. 16 is an exemplary block diagram of an activity tracker application activity tracker statistics screen 1600. The activity tracker application in this example outputs activity tracker statistics 1602 on a display associated with a user device, such as the user device 134 in FIG. 1. The statistics may include total steps 1604, total points earned 1606, and/or a minimum number of points needed 1608 to obtain a reward. In this non-limiting example, one-hundred points are required before the user may redeem a reward. If the user has forty-two points earned, the user requires an additional fifty-eight points prior to earning a reward.

FIG. 17 is an exemplary block diagram of an activity tracker application award notification screen 1700. In this non-limiting example, the user has performed 31200 steps at 1702 and earned one-hundred four points at 1704. If one-hundred points are required to redeem a reward, the user in this example has sufficient points to redeem a reward. If the user wishes to redeem a reward during a next transaction, the user may choose the get reward 1706 icon. In some examples, the user may obtain the reward in person. In other examples, the reward may be shipped or otherwise delivered to the user.

### Additional Examples

In some examples, the system tracks activity of one or more customers inside a retail store. The system assigns reward points to a customer if the number of steps taken by the customer inside the store exceeds a minimum number of steps and the transaction amount for a purchase made by the customer total exceeds a minimum amount. This prevents misuse of the reward program by only rewarding the customer if the customer purchases a minimum amount and performs the minimum number of steps during a single shopping trip.

In an example scenario, a mobile application is provided by a server associated with at least one retail/shopping store. The mobile application includes a built-in feature to detect physical activity of a customer. The physical activity is detected in the form of the number of steps taken by the customer inside the retail/shopping store. The physical activity of the customer is recorded by an activity tracker on a device worn or carried by the customer. The customer receives reward points based on the amount of the activity performed by the customer. Further, the reward point is allocated to the customer by measuring steps taken by the customer inside the store and correlating it with a shopping activity (transaction amount) of the customer. The customer automatically receives one or more reward points after completing a threshold number of steps and performing a minimum transaction amount.

A mobile application for a retail/shopping store in another example, includes a feature to detect the physical activity of a customer. The customer receives reward point(s) linked to the amount of physical activity. The reward point(s) are allocated to the customer based on the physical activity performed by the customer and shopping activity of the customer during a single transaction.

In one example, when a customer enters a store, a pedometer/accelerometer, or other activity tracker begins recording activity by the user. When the user reaches a checkout to pay for items selected for purchase, the activity rewards generator determines whether a number of steps taken by the user is greater than a minimum activity threshold. If yes, the activity rewards generator determines whether a transaction amount is greater than a minimum transaction threshold. If yes, the system generates reward points relative to the amount of activity. The activity rewards generator then determines whether a total number of points assigned to the user is greater than a minimum rewards points threshold for redeeming at least one reward. If yes, the user receives a customized reward as an incentive for performing activity within the retail environment.

In another example, instead of calculating a number of steps taken by a user, the rewards generation component calculates a number of calories burnt inside a store. If the number of calories burned exceeds a customized threshold and the transaction total exceeds a minimum transaction threshold, the activity rewards generator adds one or more rewards points to a user account associated with the user.

A mobile activity tracker application in another example includes a built-in feature for synchronizing with a pedometer/accelerometer in a customer's mobile or wearable device to track a customer's activity within a store while shopping. The customer's activity is measured until the customer reaches checkout. The customer automatically receives reward points linked to the amount of activity, which can be redeemed after a certain number of points are accumulated by the user.

Yet another example provides a mobile user device including a mobile shopping application with a built-in feature for detecting physical effort of customers in the form of steps walked inside the store, through a built-in feature on any device worn or carried by the customer. The steps taken inside the store are correlated with a basket size. Rewards are provided to the customer if the user complies with both a per-user customized basket-size requirements and a per-user customized minimum steps threshold.

The activity rewards generator in some examples increases footfalls in stores and may increase trip frequency for a customer. A customer spending $500 to obtain items in a single transaction during a two-week period may choose to split that single trip into two separate trips/transactions of $250 each. The user in this example may cumulatively spend more than the expected $500 over the same two-week period due to basket-building behaviors occurring during the two visits, as users are reminded of their fitness goals and shopping goals simultaneously.

Moreover, customers are encouraged to spend more time walking inside the retail environment, which may lead them to discover more items they might want to add to their cart. This may increase the user's average basket size while simultaneously increasing physical activity by the user for improved health and fitness.

Alternatively, or in addition to the other examples described herein, examples include any combination of the following:
a route generation component that generates a recommended route for the identified user based on current conditions within the retail environment identified using context data associated with the retail environment received from a plurality of data sources in real-time;
wherein the recommended route excludes at least one of a congested area, a high traffic area, an area requiring maintenance, an area having a wet floor surface, and an area having obstructed access;
a route generation component that generates a recommended route for the identified user based on at least one of a set of user preferences and user transaction history data;
wherein the recommended route includes a path through the retail environment comprising at least one of an area of the retail environment frequented by the identified user, an area of the retail environment including items previously purchased by the user, and an area of the retail environment including promotional items of potential interest to the user;
a threshold generator that generates the minimum transaction threshold based on retail environment data associated with the retail environment and transaction data associated with a plurality of transactions associated with the retail environment over a predetermined time-period;
a communications interface component that outputs a recommended route through a retail environment to a user device associated with an identified user detected entering the retail environment;
wherein the recommended route includes a path through at least one area of the retail environment requiring the minimum activity threshold to complete;
wherein the activity verification component utilizes the verification data to verify completion of the recommended route by the identified user prior to completion of the transaction;
an activity tracker that retrieves activity data associated with activity of the identified user within the retail environment associated with a single transaction from an activity tracker application associated with the at least one user device to calculate the activity value associated with the identified user prior to completion of the transaction;
a customized reward generator that analyzes at least one of a set of user preferences, user transaction history data, promotional items data, and context data associated with the retail environment to generate a reward customized for the identified user based on a total number of reward points assigned to the identified user within a predetermined time-period;
a time-out component that determines if a time-period between an exit from the retail environment prior to completion of the transaction by the identified user and a re-entry back into the retail environment exceeds a threshold time-out period;
wherein an activity tracker continues calculating the activity value associated with the identified user after re-entry into the retail environment on condition the time-period between the exit and the re-entry is within the threshold time-out period, and wherein the activity tracker ceases calculating the activity value associated with the identified user after re-entry if the time-period between the exit and the re-entry is greater than the threshold time-out period;
a reward verification component, implemented on the at least one processor, that verifies a total number of reward points assigned to the identified user within a predetermined time-period is within a threshold maximum number of points permitted within the predetermined time-period;
wherein the incentives generator ceases assigning rewards points if the threshold number of rewards points permitted within the predetermined period have already been assigned to the identified user;
calculating a number of rewards points corresponding to the amount of activity performed by the identified user;
comparing the calculated number of rewards points to a per-transaction maximum points threshold;
on condition the calculated number of rewards points exceeds per-transaction maximum points threshold, assigning the per-transaction maximum points threshold to the identified user;
on condition the per-transaction maximum points threshold exceeds the calculated number of points, assigning the calculated number of reward points to the identified user;
generating, by a route generation component, a recommended route customized for the identified user based on at least one of context data associated with current conditions within the retail environment, transaction data associated with the identified user, and user data associated with the identified user, the recommended route comprising a customized path through at least one area within the retail environment;
outputting, by a communications interface component, the recommended route to a user device associated with the identified user on detecting the identified user entering the retail environment;
wherein completion of the recommended route within the retail environment by the identified user prior to completion of the transaction satisfies the minimum activity threshold;
on detecting the identified user exiting the retail environment prior to completing the transaction, calculating, by a time-out component, a time-period between the exit from the retail environment and a re-entry of the identified user back into the retail environment;
determining whether the calculated time-period exceeds a threshold time-out period, wherein an activity tracker continues counting steps taken by the identified user after re-entry into the retail environment on condition the time-period between the exit and the re-entry is within the threshold time-out period;
wherein the activity tracker ceases counting steps taken by the identified user after re-entry if the time-period between the exit and the re-entry is greater than the threshold time-out period;
on determining the identified user is walking, calculating, by the activity tracker, the amount of activity performed by the identified user based on a number of steps taken by the identified user within the retail environment;
on determining the identified user is disabled, calculating the amount of activity performed by the identified user based on an alternative activity performance indicator;
selecting, by the transaction verification component, the minimum transaction threshold from a set of transaction threshold values based on a basket size associated with the transaction completed by the identified user;
wherein a first minimum transaction threshold is selected for a first basket size and a different second minimum transaction threshold is selected for a second basket size, wherein the basket size indicates at least one of a number of items in the set of items purchased and a total purchase price paid for the set of items purchased;
calculating, by the activity tracker, a number of calories burned by the identified user within the time-period between entering the retail environment and completing the transaction associated with the purchase of the set of items;
calculating, by the activity tracker, the amount of activity performed by the identified user based on the calculated number of calories burned;
generating a recommended route customized for the identified user based on at least one of context data associated with current conditions within the retail environment, transaction data associated with the identified user, and data associated with the identified user, the recommended route comprising a customized path through at least one area within the retail environment;
outputting the recommended route to a user device associated with the identified user on detecting the identified user entering the retail environment, wherein completion of the recommended route within the retail environment by the identified user prior to completion of the transaction satisfies the minimum activity threshold;
generating the minimum activity threshold for the identified user entering the retail environment based on at least one of a set of activity variables, user transaction history, and data associated with the retail environment, wherein the minimum activity threshold is customized for the retail environment and the identified user;
generating a customized reward for the identified user on condition a total number of points assigned to the identified user exceeds a minimum reward threshold, the customized reward is generated based on an analysis of data comprising at least one of a set of user preferences, user transaction history data, promotional items data, and context data associated with the retail environment; and
outputting a notification regarding the customized reward to a user device associated with the identified user.

At least a portion of the functionality of the various elements in FIG. 1, FIG. 2, FIG. 3, FIG. 4, FIG. 5, FIG. 6, FIG. 7, FIG. 8, and FIG. 9 may be performed by other elements in FIG. 1, FIG. 2, FIG. 3, FIG. 4, FIG. 5, FIG. 6, FIG. 7, FIG. 8, and FIG. 9 or an entity (e.g., processor, web service, server, application program, computing device, etc.) not shown in FIG. 1, FIG. 2, FIG. 3, FIG. 4, FIG. 5, FIG. 6, FIG. 7, FIG. 8, and FIG. 9.

In some examples, the operations illustrated in FIG. 10, FIG. 11, FIG. 12, and FIG. 13 may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

While the aspects of the disclosure have been described in terms of various examples with their associated operations, a person skilled in the art would appreciate that a combination of operations from any number of different examples is also within scope of the aspects of the disclosure.

The term “Wi-Fi” as used herein refers, in some examples, to a wireless local area network using high frequency radio signals for the transmission of data. The term “BLUETOOTH” as used herein refers, in some examples, to a wireless technology standard for exchanging data over short distances using short wavelength radio transmission. The term “cellular” as used herein refers, in some examples, to a wireless communication system using short-range radio stations that, when joined together, enable the transmission of data over a wide geographic area. The term “NFC” as used herein refers, in some examples, to a short-range high frequency wireless communication technology for the exchange of data over short distances.

While no personally identifiable information is tracked by aspects of the disclosure, examples have been described with reference to data monitored and/or collected from the users. In some examples, notice may be provided to the users of the collection of the data (e.g., via a dialog box or preference setting) and users are given the opportunity to give or deny consent for the monitoring and/or collection. The consent may take the form of opt-in consent or opt-out consent.

### Exemplary Operating Environment

Exemplary computer readable media include flash memory drives, digital versatile discs (DVDs), compact discs (CDs), floppy disks, and tape cassettes. By way of example and not limitation, computer readable media comprise computer storage media and communication media. Computer storage media include volatile and nonvolatile, removable and non-removable media implemented in any method or technology for storage of information such as computer readable instructions, data structures, program modules and the like. Computer storage media are tangible and mutually exclusive to communication media. Computer storage media are implemented in hardware and exclude carrier waves and propagated signals. Computer storage media for purposes of this disclosure are not signals per se. Exemplary computer storage media include hard disks, flash drives, and other solid-state memory. In contrast, communication media typically embody computer readable instructions, data structures, program modules, or the like, in a modulated data signal such as a carrier wave or other transport mechanism and include any information delivery media.

Although described in connection with an exemplary computing system environment, examples of the disclosure are capable of implementation with numerous other general purpose or special purpose computing system environments, configurations, or devices.

Examples of well-known computing systems, environments, and/or configurations that may be suitable for use with aspects of the disclosure include, but are not limited to, mobile computing devices, personal computers, server computers, hand-held or laptop devices, multiprocessor systems, gaming consoles, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein.

In examples involving a general-purpose computer, aspects of the disclosure transform the general-purpose computer into a special-purpose computing device when configured to execute the instructions described herein.

The examples illustrated and described herein as well as examples not specifically described herein but within the scope of aspects of the disclosure constitute exemplary means for generating customized activity-based rewards. For example, the elements illustrated in FIG. 1, FIG. 2, FIG. 3, FIG. 4, FIG. 5, FIG. 6, FIG. 7, FIG. 8, and FIG. 9, such as when encoded to perform the operations illustrated in FIG. 10, FIG. 11, FIG. 12, and FIG. 13, constitute exemplary means for generating a per-user minimum activity threshold and activity type based on context data associated with a retail environment, user data, and transaction data associated with a plurality of transactions completed by an identified user over a predetermined time-period; exemplary means for analyzing verification data received from at least one of a user device or a set of sensor devices associated with the retail environment; exemplary means for verifying an activity value associated with the identified user prior to completion of a transaction by the identified user exceeds the per-user for the activity type; exemplary means for analyzing transaction data generated by at least one point of sale (POS) device associated with the retail environment on completion of the transaction by the identified user; exemplary means for verifying a transaction total associated with the transaction completed by the identified user exceeds a minimum transaction threshold; and exemplary means for assigning a number of reward points to the identified user on condition the transaction total exceeds the minimum transaction threshold and the activity value exceeds the per-user minimum activity threshold prior to completion of the transaction.

In another example, the elements illustrated in FIG. 1, FIG. 2, FIG. 3, FIG. 4, FIG. 5, FIG. 6, FIG. 7, FIG. 8, and FIG. 9, such as when encoded to perform the operations illustrated in FIG. 10, FIG. 11, FIG. 12, and FIG. 13, constitute exemplary means for generating a customized minimum activity threshold for an identified user entering a retail environment based on a set of activity variables and data associated with the retail environment; constitute exemplary means for calculating an amount of activity performed by the identified user within the retail environment within a time-period between entering the retail environment and completing a transaction associated with a purchase of a set of items; constitute exemplary means for analyzing transaction data associated with the transaction to verify a transaction total exceeds a minimum transaction threshold on condition the amount of activity performed by the identified user exceeds the customized minimum activity threshold for the identified user; and exemplary means for assigning a set of rewards points corresponding to the amount of activity performed by the user on condition the transactions total associated with the completed transaction exceeds the minimum transaction threshold.

In still another example, the elements illustrated in FIG. 1, FIG. 2, FIG. 3, FIG. 4, FIG. 5, FIG. 6, FIG. 7, FIG. 8, and FIG. 9, such as when encoded to perform the operations illustrated in FIG. 10, FIG. 11, FIG. 12, and FIG. 13, constitute exemplary means for generating a customized minimum transaction threshold for an identified user entering a retail environment based on retail environment data associated with the retail environment and transaction data associated with a plurality of transactions associated with the retail environment over a predetermined time-period; exemplary means for calculating a transaction total for a selected transaction completed by the identified user; exemplary means for identifying an amount of activity performed by the identified user within the retail environment within a time-period between entering the retail environment and completing the selected transaction on condition the calculated transaction total exceeds the customized minimum transaction threshold; exemplary means for calculating a number of rewards points corresponding to the amount of activity performed by the user on condition the amount of activity performed by the identified user exceeds a minimum activity threshold for the identified user; and exemplary means for assigning the calculated number of reward points to the identified user on condition a threshold maximum number of rewards points exceeds the calculated number of rewards points.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for activity-based reward generation, the system comprising:
a memory;
at least one processor communicatively coupled to the memory;
a threshold generator, implemented on the at least one processor, that generates a per-user minimum activity threshold and activity type based on context data associated with a retail environment, user data, and transaction data associated with a plurality of transactions completed by an identified user over a predetermined time-period;
an activity verification component, implemented on the at least one processor, that analyzes verification data received from at least one of a user device or a set of sensor devices associated with the retail environment to verify an activity value associated with the identified user prior to completion of a selected transaction by the identified user exceeds the per-user minimum activity threshold for the activity type;
a transaction verification component, implemented on the at least one processor, that analyzes transaction data associated with the selected transaction by the identified user to verify a transaction total associated with the selected transaction exceeds a minimum transaction threshold; and
an incentives generator, implemented on the at least one processor, that assigns a number of reward points to the identified user on condition the selected transaction total exceeds the minimum transaction threshold and the activity value exceeds the per-user minimum activity threshold prior to completion of the selected transaction.

2. The system of claim 1, further comprising:
a route generation component, implemented on the at least one processor, that generates a recommended route for the identified user based on current conditions within the retail environment identified using context data associated with the retail environment received from a plurality of data sources in real-time, wherein the recommended route excludes at least one of a congested area, a high traffic area, an area requiring maintenance, an area having a wet floor surface, and an area having obstructed access.

3. The system of claim 1, further comprising:
a route generation component, implemented on the at least one processor, that generates a recommended route for the identified user based on at least one of a set of user preferences and user transaction history data, wherein the recommended route comprises a path through the retail environment comprising at least one of an area of the retail environment frequented by the identified user, an area of the retail environment including items previously purchased by the user, and an area of the retail environment including promotional items of potential interest to the user.

4. The system of claim 1, wherein the threshold generator generates a per-user minimum transaction threshold for the identified user based on the retail environment data, the user data, and the context data.

5. The system of claim 1, further comprising:
a communications interface component, implemented on the at least one processor, that outputs a recommended route through a retail environment to a user device associated with an identified user detected entering the retail environment, the recommended route comprising a path through at least one area of the retail environment requiring the minimum activity threshold to complete, wherein the activity verification component utilizes the verification data to verify completion of the recommended route by the identified user prior to completion of the selected transaction.

6. The system of claim 1, further comprising:
an activity tracker, implemented on the at least one processor, that retrieves activity data associated with activity of the identified user within the retail environment associated with the selected transaction from an activity tracker application associated with the at least one user device to calculate the activity value associated with the identified user prior to completion of the selected transaction.

7. The system of claim 1, further comprising:
a customized reward generator, implemented on the at least one processor, that analyzes at least one of a set of user preferences, user transaction history data, promotional items data, and context data associated with the retail environment to generate a reward customized for the identified user based on a total number of reward points assigned to the identified user within a predetermined time-period.

8. The system of claim 1, further comprising:
a time-out component, implemented on the at least one processor, that determines if a time-period between an exit from the retail environment prior to completion of the selected transaction by the identified user and a re-entry back into the retail environment exceeds a threshold time-out period, wherein an activity tracker continues calculating the activity value associated with the identified user after re-entry into the retail environment on condition the time-period between the exit and the re-entry is within the threshold time-out period, and wherein the activity tracker ceases calculating the activity value associated with the identified user after re-entry if the time-period between the exit and the re-entry is greater than the threshold time-out period.

9. The system of claim 1, further comprising:
a reward verification component, implemented on the at least one processor, that verifies a total number of reward points assigned to the identified user within a predetermined time-period is within a threshold maximum number of points permitted within the predetermined time-period, wherein the incentives generator ceases assigning rewards points if the threshold number of rewards points permitted within the predetermined period have already been assigned to the identified user.

10. A computer-implemented method for activity-based reward generation, the computer-implemented method comprising:
generating, by a threshold generator, a customized minimum activity threshold for an identified user entering a retail environment based on a set of activity variables and data associated with the retail environment;
calculating, by an activity tracker, an amount of activity performed by the identified user within the retail environment within a time-period between entering the retail environment and completing a selected transaction associated with a purchase of a set of items;
on condition the amount of activity performed by the identified user exceeds the customized minimum activity threshold for the identified user, analyzing, by a transaction verification component, transaction data associated with the selected transaction to verify a transaction total exceeds a minimum transaction threshold; and
on condition the transactions total associated with the selected transaction exceeds the minimum transaction threshold, assigning, by an incentives generator, a set of rewards points corresponding to the amount of activity performed by the user.

11. The computer-implemented method of claim 10, further comprising:
calculating a number of rewards points corresponding to the amount of activity performed by the identified user;
comparing the calculated number of rewards points to a per-transaction maximum points threshold;
on condition the calculated number of rewards points exceeds per-transaction maximum points threshold, assigning the per-transaction maximum points threshold to the identified user; and
on condition the per-transaction maximum points threshold exceeds the calculated number of points, assigning the calculated number of reward points to the identified user.

12. The computer-implemented method of claim 10, further comprising:
generating, by a route generation component, a recommended route customized for the identified user based on at least one of context data associated with current conditions within the retail environment, transaction data associated with the identified user, and user data associated with the identified user, the recommended route comprising a customized path through at least one area within the retail environment; and
outputting, by a communications interface component, the recommended route to a user device associated with the identified user on detecting the identified user entering the retail environment, wherein completion of the recommended route within the retail environment by the identified user prior to completion of the selected transaction satisfies the minimum activity threshold.

13. The computer-implemented method of claim 10, further comprising:
on detecting the identified user exiting the retail environment prior to completing the selected transaction, calculating, by a time-out component, a time-period between the exit from the retail environment and a re-entry of the identified user back into the retail environment; and
determining whether the calculated time-period exceeds a threshold time-out period, wherein an activity tracker continues counting steps taken by the identified user after re-entry into the retail environment on condition the time-period between the exit and the re-entry is within the threshold time-out period, and wherein the activity tracker ceases counting steps taken by the identified user after re-entry if the time-period between the exit and the re-entry is greater than the threshold time-out period.

14. The computer-implemented method of claim 10, further comprising:
on determining the identified user is walking, calculating, by the activity tracker, the amount of activity performed by the identified user based on a number of steps taken by the identified user within the retail environment; and
on determining the identified user is disabled, calculating the amount of activity performed by the identified user based on an alternative activity performance indicator.

15. The computer-implemented method of 10, further comprising:
selecting, by the transaction verification component, a the minimum transaction threshold from a set of transaction threshold values based on a basket size associated with the selected transaction completed by the identified user, wherein a first minimum transaction threshold is selected for a first basket size and a different second minimum transaction threshold is selected for a second basket size, wherein the basket size indicates at least one of a number of items in the set of items purchased and a total purchase price paid for the set of items purchased.

16. The computer-implemented method of claim 10, further comprising:
calculating, by the activity tracker, a number of calories burned by the identified user within the time-period between entering the retail environment and completing the selected transaction associated with the purchase of the set of items; and
calculating, by the activity tracker, the amount of activity performed by the identified user based on the calculated number of calories burned.

17. One or more computer storage media, having computer-executable instructions for activity-based reward generation that, when executed by a computer cause the computer to perform operations comprising:
generating a customized minimum transaction threshold for an identified user entering a retail environment based on retail environment data associated with the retail environment and transaction data comprising data associated with a plurality of transactions of the retail environment over a predetermined time-period;
calculating a transaction total for a selected transaction completed by the identified user;
on condition the calculated transaction total exceeds the customized minimum transaction threshold, identifying an amount of activity performed by the identified user within the retail environment within a time-period between entering the retail environment and completing the selected transaction;
on condition the amount of activity performed by the identified user exceeds a minimum activity threshold for the identified user, calculating a number of rewards points corresponding to the amount of activity performed by the user; and
on condition a threshold maximum number of rewards points exceeds the calculated number of rewards points, assigning the calculated number of reward points to the identified user.

18. The one or more computer storage media of claim 17, wherein the computer-executable instructions for activity-based reward generation further comprises:
generating a recommended route customized for the identified user based on at least one of context data associated with current conditions within the retail environment, transaction data associated with the identified user, and data associated with the identified user, the recommended route comprising a customized path through at least one area within the retail environment; and
outputting the recommended route to a user device associated with the identified user on detecting the identified user entering the retail environment, wherein completion of the recommended route within the retail environment by the identified user prior to completion of the selected transaction satisfies the minimum activity threshold

19. The one or more computer storage media of claim 18, wherein the comprising computer-executable instructions for activity-based reward generation further comprises:
generating the minimum activity threshold for the identified user entering the retail environment based on at least one of a set of activity variables, user transaction history data, and data associated with the retail environment, wherein the minimum activity threshold is customized for the retail environment and the identified user.

20. The one or more computer storage media of claim 17, wherein the computer-executable instructions for activity-based reward generation further comprises:
generating a customized reward for the identified user on condition a total number of points assigned to the identified user exceeds a minimum reward threshold, the customized reward is generated based on an analysis of data comprising at least one of a set of user preferences, user transaction history data, promotional items data, and context data associated with the retail environment; and
outputting a notification regarding the customized reward to a user device associated with the identified user.
